(19) United States
(12) Patent Application Publication
(10) Pub. No.: US 2021/0354149 A1
(43) Pub. Date: Nov. 18, 2021

(54) DESCALING NOZZLE ASSEMBLY

(71) Applicant: Spraying Systems Co., Wheaton, IL (US)

(72) Inventors: Taha R. Tayebali, Burlington, MA (US); Lesli Peterson, Fishers, IN (US); Oldair F. Sasso, Wheaton, IL (US)

(21) Appl. No.: 17/320,695

(22) Filed: May 14, 2021

Related U.S. Application Data
(60) Provisional application No. 63/025,760, filed on May 15, 2020.

(51) Int. Cl. B05B 1/10; B08B 3/02

(52) U.S. Cl. CPC B05B 1/10; B08B 3/022

(57) ABSTRACT

A spray nozzle assembly for directing thin, straight line, high pressure liquid spray onto moving steel slabs for penetrating and removing scale buildup in steel processing operations. The spray nozzle assembly includes a liquid inlet defined by an upstream strainer and a downstream high impact attachment tube for accelerating liquid flow. A one-piece multi-stage liquid straightening vane segment is disposed within a central liquid flow passage of the nozzle assembly for more effectively reducing liquid turbulence of the high pressure liquid flow with resultant improved control in the tightness of the thin, flat spray panner. The one-piece vane segment further is adapted for efficient assembly and replacement in the spray nozzle assembly without the need for handling and precise alignment of a plurality of individual vane elements.

### CROSS-REFERENCE TO RELATED APPLICATIONS

This patent application claims the benefit of U.S. Provisional Patent Application No. 63/025,760 filed May 15, 2020, which is incorporated by reference.

### FIELD OF THE INVENTION

The present invention relates generally to spray nozzle assemblies, and more particularly, to descaling spray nozzle assemblies particularly effective for directing a wide thin-line high-pressure liquid discharge for penetrating and removing scale from steel in steel manufacturing operations.

### BACKGROUND OF THE INVENTION

Descaling spray nozzle assemblies are extensively used in steel processing for directing a wide thin line high pressure spray onto the surface of steel slabs for penetrating and removing iron oxide scale buildup on the surfaces prior to rolling and subsequent processing of the steel. In such spraying systems, it is desirable that the high pressure liquid discharge be as thin as possible for effecting maximum impact pressure and penetration of the scale. It also is desirable that the distribution of the liquid discharge be uniform across the width of the spray pattern.

Such descaling spray nozzle assemblies typically comprise a tubular body, sometimes referred to as a high impact attachment tube, formed with a liquid flow passageway that tapers inwardly in a downstream direction for accelerating the liquid flow, a strainer affixed to an upstream end of the tubular body for straining particulate matter and scale from recycled steel mill water typically used in such descaling processing, and a tungsten carbide insert tip mounted at downstream end of the tubular body having an elongated liquid discharge orifice for forming and directing a flat spray discharge pattern. High pressure liquid, commonly at pressures of 2000 to 4000 psi, directed through the strainer typically makes a right angle turn into the high impact attachment tube, creating extensive turbulence that can adversely affect the uniformity and impact force of the discharging spray.

For reducing turbulence and straightening the liquid flow stream through the high impact attachment tube prior to passage through the spray tip, it is known to provide a vane having a plurality of radial vane elements downstream of the strainer, which effectively defines a plurality of circumferentially-spaced laminar flow passages. It also is known to use multiple vanes that are assembled in staged axially spaced, circumferentially offset relation to each other for further enhanced liquid straightening.

Even with such vanes considerable turbulence in the high pressure flow stream can remain, in part created by the vanes themselves, which reduces energy of the liquid and detracts from the impact force of the discharging spray. Wear on the veins from the high pressure liquid also can detract from efficient liquid straightening performance. Moreover, the use of multiple staged vanes requires precise assembly and alignment of the vanes in proper relation to each other which can impede efficient assembly and replacement.

### OBJECTS AND SUMMARY OF THE INVENTION

It is an object of the present invention to provide a descaling spray nozzle assembly that more effectively directs and guides liquid through the spray nozzle assembly with the reduced turbulence and energy losses.

Another object is to provide a descaling spray nozzle assembly as characterized above which has multiple staged liquid straightening vanes that more effectively reduce turbulence and energy losses of the liquid flow stream that can alter impact forces of the discharging liquid spray.

It is a further object to provide a descaling spray nozzle assembly of the above kind in which the liquid straightening vanes are less susceptible to wear from the high pressure liquid directed through the spray nozzle assembly after prolonged periods.

A further object is to provide a descaling spray nozzle assembly of the foregoing type that has a plurality of liquid straightening vanes that is adapted for easier and more efficient assembly. A related object is to provide a descaling spray nozzle assembly of such type that eliminates the need for handling and precise assembly of a plurality of individual vanes.

Yet a further object is to provide a descaling spray nozzle assembly of the foregoing type that is relative simple in design and lends itself to economical manufacture.

Other objects and advantages of the invention will become apparent upon reading the following detailed description and upon references to the drawings, in which:

### BRIEF DESCRIPTION OF THE DRAWINGS

FIG. 1 is a diagrammatic end elevational view of an illustrative descaling spraying system having spray nozzle assemblies in accordance with the invention;

FIG. 2 is an enlarged fragmentary section of one of the descaling spray nozzle assemblies of the illustrative spraying systems;

FIG. 3 is an enlarged downstream end view of the illustrated spray nozzle assembly taken in the plane of line 3-3 in FIG. 2;

FIG. 4 is an enlarged longitudinal section of the tungsten carbide insert spray tip of the illustrated spray nozzle assembly;

FIG. 5 is an enlarged longitudinal section of the spray nozzle assembly shown in FIG. 2, taken in the plane of line 5-5;

FIG. 6 is an enlarged side plane view of a one-piece vane segment of the illustrated spray nozzle assembly;

FIG. 7 is a longitudinal section of the one-piece vane segment shown in FIG. 6;

FIG. 7A is an enlarged detailed view of the upstream end of one of the vane sections of the illustrated one-piece vane segment depicted in FIG. 7;

FIG. 7B is an enlarged detailed view of depicting ends of the vane elements of the illustrated one-piece vane segment;

FIG. 8 is an upstream end view of the illustrated one-piece vane segment;

FIG. 9 is a downstream end view of the illustrated one-piece vane segment;

FIG. 10 is a transverse section taken in the line of 10-10 line 10-10 in FIG. 6; and

FIG. 11 is a transverse section taken in the plane of line 11-11 in FIG. 6.

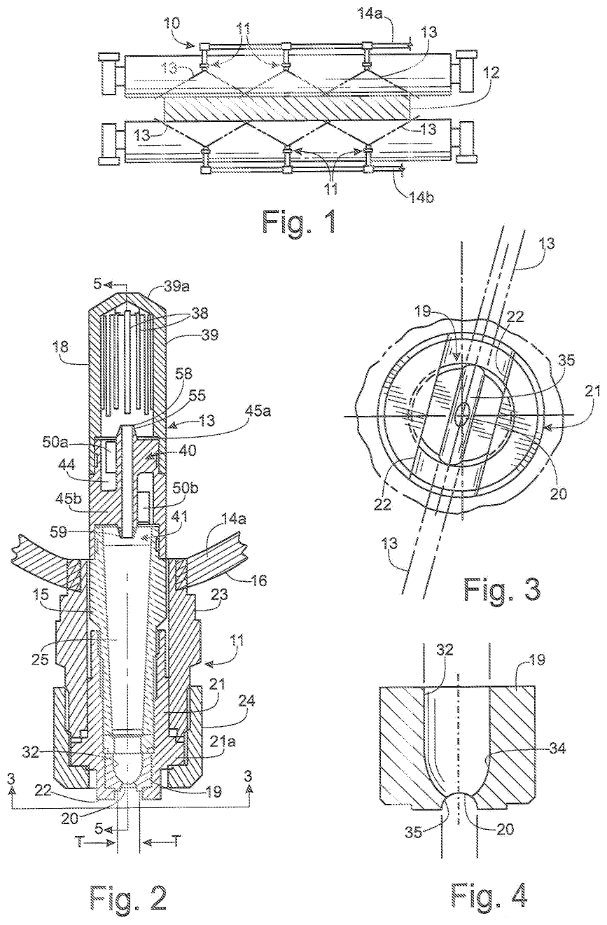

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

Referring now more particularly to the drawings, there is shown an illustrative descaling spraying system 10 having a plurality of spray nozzle assemblies 11 in accordance with the invention for directing a high pressure liquid spray on opposed sides of a moving steel slab 12 in a steel manufacturing operation. The spraying system 10 in this case comprises upper and lower liquid supply headers 14a, 14b, typically supplied with mill water that is recycled in the steel manufacturing facility. These spray nozzle assemblies 11 are mounted in laterally-spaced relation along the respective header 14a, 14b such that a plurality of flat, thin-line spray patterns 13 penetrate and remove scale across the entire width of the steel slab 12. The spray nozzle assemblies 11 in this case are supported in depending fashion from the upper liquid supply header 14a for directing liquid spray onto an upper side of the moving slab 12 and spray nozzle assemblies 11 are supported in upwardly extending relation to the lower liquid supply header 14b for directing spray patterns across the underside of the slab 12. Each spray nozzle assembly 11 is supported by its respective header 14a, 14b with an upstream end within the header for receiving supply liquid from the header and a downstream end disposed outside the header in facing relation to the moving slab 12. Since each of the spray nozzle assemblies 11 are of similar construction, only one need be described herein in detail.

The illustrated spray nozzle assemblies 11 each have an elongated nozzle body 13 comprising an upstream section in the form of an elongated generally cup-shaped liquid strainer 18 through which supply water from the header 14a, 14b enters the spray nozzle assembly 11 and a downstream section in the form of an elongated high impact attachment tube 15 supported within a wall 16 of the header 14a, 14b. A tungsten carbide insert spray tip 19 is mounted at a downstream end of the high impact attachment tube 15 formed with an elongated discharge orifice 20 for discharging and directing a flat spray pattern, and a spray tip retainer 21 secures the spray tip 19 in mounted position. The spray tip retainer 21 is threaded onto a downstream end of the high impact attachment tube 15 with an inwardly directed annular lip 22 retaining the spray tip 19 in abutting relation against a downstream end of the high impact attachment tube 15.

The spray nozzle assembly 11 in this instance is supported within the header by means of a cylindrical adapter 23 appropriately fixed within a radial opening in the header 16. The adapter 23 has an externally threaded lower end against which an outwardly extending radial flange 21a of the spray tip retainer 21 is retained by an internally threaded retaining ring 24 secured to the cylindrical adapter 23.

For accelerating liquid during passage through the spray nozzle assembly, the high impact attachment tube 15 is formed with a liquid flow passage 25 which tapers inwardly in a downstream direction. The tungsten carbide insert spray tip 19 affixed to the downstream end of high impact attachment tube 15 in this case is formed with an inlet passage section 32 that communicates between the high impact attachment tube passageway 25 and the discharge orifice 20 through a radiused entry passage section 34 (FIG. 4). The elongated discharge orifice 20 in this instance is defined by a cylindrical groove or cut 35 extending transversely across the end of the spray tip 19 in intersecting relation with the entry passage section 34.

For straining small particulate matter that might exist in the recycled mill water directed through the headers 14a, 14b from the flow stream entering the spray nozzle assembly 11, the strainer 18 is formed with a plurality of elongated slits 38 circumferentially about the strainer communicating through a cylindrical sidewall 39 of the strainer and partially into the upstream end 39a thereof. The supply water primarily enters the strainer 18 in a radial direction through the elongated slits 38 and must make a 90° change in directional movement, causing significant turbulence in the liquid, as it is directed toward the inwardly tapered passageway 25 of the high impact attachment tube 15 prior to direction from the spray tip 19. Turbulence in the high pressure liquid flow stream directed to the spray tip 19, as indicated above, can adversely affect the liquid discharge, particularly by increasing the transverse thickness of the thin line spray pattern, which reduces the liquid impact force and penetration, and thereby altering the liquid distribution, particularly at opposite ends of the wide spray pattern, which can result in uneven liquid penetration and scale removal.

In accordance with an important aspect of the present embodiment, the spray nozzle assembly has a one-piece multi-stage liquid straightening vane segment 40 disposed within a central liquid flow passage 41 of the nozzle body 13 defined by the upstream strainer 18 and the high impact attachment tube 15 that more effectively reduces liquid turbulence prior to direction to and through the spray tip 19, with resultant improved control in tightness of the thin, flat spray pattern and uniformity in liquid distribution throughout the spray pattern. The illustrated one-piece multi-stage liquid straightening vane segment 40 includes a plurality of integrally formed, and circumferentially offset liquid straightening vane sections 45a, 45b, which lends itself to easier and more efficient assembly and replacement in the spray nozzle assembly without cumbersome handling of a plurality of individual vane components. The illustrated one-piece vane segment 40 in this case comprises a central longitudinally extending hub 44 with a first or upstream vane section 45a that includes a plurality of flat vane elements 46a extending radially outwardly of the central hub 44 in radial planes through the longitudinal axis of the central liquid flow passage 41 and a second or downstream vane section 45b downstream of the first vane section 45a that includes a plurality of similar flat vane elements 46b extending radially outwardly of the common central longitudinal hub 44 in circumferentially offset relation to the vane elements 45a of the first vane section 45a.

The illustrated one-piece vane segment 40 has an outer cylindrical collar 48 integrally formed in surrounding relation to the vane elements 46a 46b of both the upstream and downstream vane sections 46a, 46b. The outer collar 48, central hub 44, and the vane elements 46a of the upstream vane section 45a define a plurality of circumferentially spaced enclosed laminar flow passages 50a, (FIG. 11), and the outer collar 48, central hub 44 and vane elements 46b of the downstream vane section 45b define a second circumferential array of enclosed laminar flow passages 50b circumferentially offset from the laminar passages 50b of the first vane section 45a (FIG. 10). In the illustrated embodiment, the vane sections 45a, 45b each have five radial vane elements 46a, 46b extending between the common central hub 44 and outer collar 48 for defining five circumferentially spaced laminar flow passages 50a, 50b, with the vane elements 46b of the downstream vane section 45b, as viewed in a longitudinal direction, being disposed midway between the vane elements 46a of the upstream vane section 45a. Preferably, the vane sections 45a, 45b each have a common number of vane elements 46a, 46b between four and six

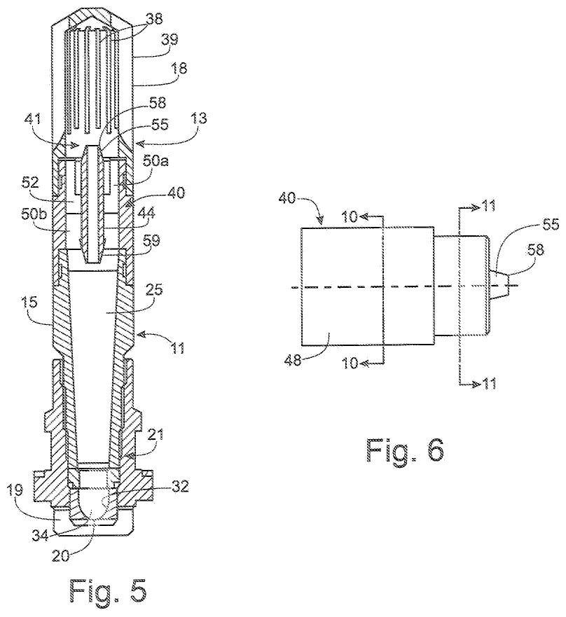

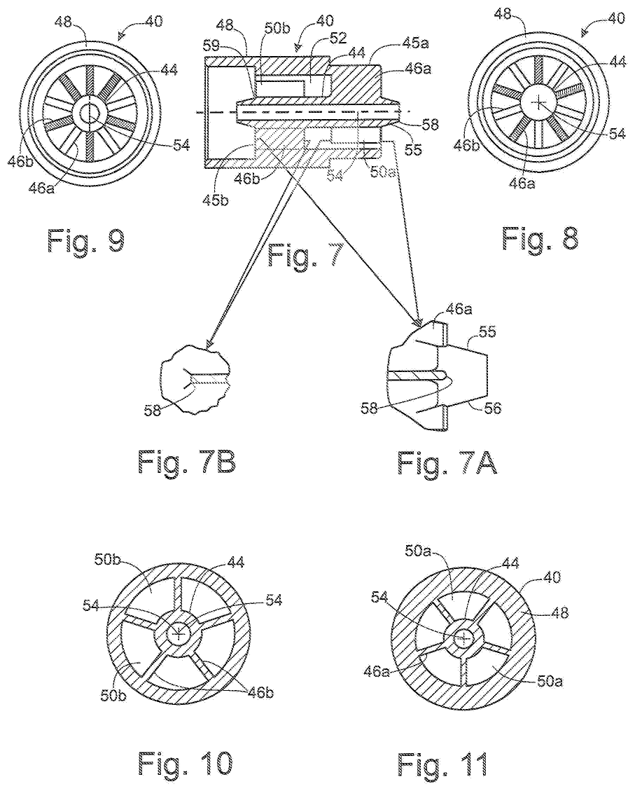

The vane elements 46b of the downstream vane section 46b are axially spaced and circumferentially offset from the radial vane elements 46a of the upstream vane section 45a for providing a staged straightening of the high pressure liquid 46a through the vane segment 40 prior to entering the high impact attachment tube 15. In the illustrated embodiment, when viewed in a longitudinal direction, the vane elements 46b of the downstream vane section 45b are aligned in midway relation to the laminar flow passages 50a of the upstream vane section 45a. The vane elements 46a, 46b in this case each have an equal longitudinal length L and are separated by an axial gap D (FIGS. 5 and 7) which defines the length of a transition flow passage 52 between the vane sections 45a, 45b. In a preferred embodiment, the gap D is less than one half the axial length of the individual length of vane elements 46a, 46b.

In keeping with a further aspect of the present embodiment, the vane segment 40 has a streamlined design for reducing turbulence and energy losses in the high pressure liquid flow stream directed through the vane segment 40. More particularly, the vane segment 40 is designed to minimize blunt surfaces that tend to impede and impart further turbulence to the high pressure liquid flow stream. To this end, the central hub 44 is formed with a longitudinal central passage 54 that defines a further laminar flow passageway through the vane segment 40. The central hub 44 further has a protrusion 55 extending upstream of the upstream valve section 45a formed with a frustoconical outer liquid guide surface 56 (FIGS. 7 and 7B) that tapers radially outwardly in a downstream direction. The frustoconical liquid guide surface 56 in turn intersects the central liquid passage 54 of the hub 44 for defining a pointed annular entry end 58 both to the central liquid passage 54 and the frustoconical liquid guide surface 56. It has been found that such upstream protrusion 55 both facilitates direction of liquid into the central liquid passage 54 and onto the frustoconical liquid guide surface 56 and into laminar flow passages 50a of the upstream valve section 45a in a more controlled fashion without blunt surfaces that impart further turbulence to the high pressure liquid flow stream. To further facilitate the direction of liquid into the laminar flow passages 50a, the vane elements 46a, 46b of the upstream and downstream valve section 45a, 45b have upstream pointed end 58s, as depicted in FIG. 7A The central hub 44 in this case further has a downstream protrusion 59 with an outer frustoconical surface tapered inwardly in a downstream direction, again for guiding liquid from the laminar flow passages 46b of the downstream valve section 45b into the high pressure attachment tube 25.

In further carrying out this embodiment, the spray nozzle assembly 11 is adapted for efficient assembly with the vane segment 40 comprising a discrete section of the nozzle body 13 of the spray nozzle assembly. To that end, the vane segment 40 is mounted in interposed relation between the upstream section of the nozzle body, namely the liquid strainer 18 in this case, and the downstream section of the nozzle body, namely the high impact attachment tube 15 in this case. In the illustrated embodiment, a downstream end of the strainer 18 is fixedly crimped onto an upstream end of the vane segment collar 48, and the downstream end of the vane segment collar 48 is crimped onto the upstream end of high impact attachment tube 15. The collar 48 of the vane segment 40 in this case has a diameter coinciding with that of the high impact attachment tube 15 and strainer 18. It will be appreciated that such spray nozzle assembly 11 can be easily assembled without handling or precise alignment of multiplicity of liquid straightening vanes.

From the foregoing, it can been seen that a descaling spray nozzle assembly is provided for more effectively and efficiently straightening the liquid flow through the spray nozzle assembly with reduced turbulence and energy losses. The one-piece multi-staged liquid straightening vane segment further minimizes turbulence and energy losses of the liquid flow stream that can alter impact forces of the discharging liquid spray and is less susceptible to wear from high pressure liquid directed through the spray nozzle assembly after prolonged periods. The spray nozzle assembly, furthermore, is adapted for easier and more efficient assembly and replacement without need for handling and precise alignment to a plurality of individual vane elements.

1. A high impact liquid spray nozzle assembly comprising an elongated nozzle body having liquid passageway with a section that extends with an inwardly tapered diameter in a downstream direction along a longitudinal axis of the liquid passageway, a spray tip at a downstream end of said nozzle body having an elongated discharge orifice oriented transverse to the longitudinal axis of the liquid passageway for emitting and directing a flat liquid spray pattern, a liquid inlet communicating with an upstream end of said nozzle body liquid passageway upstream of said spray tip, a one-piece multi-stage vane segment disposed in said liquid passageway upstream of said spray tip, said one-piece vane segment comprising an upstream vane section and a downstream vane section downstream of said upstream vane section, said upstream and downstream vane sections each having a plurality of flat vane elements defining a plurality of longitudinally extending circumferentially spaced laminar flow passageways communicating between said liquid inlet and said spray tip for directing liquid longitudinally in a direction parallel to the longitudinal axis of the liquid passageway, and said radial vane elements of said downstream vane section being circumferentially offset to the radial vane elements of said upstream vane section.

2. The spray nozzle assembly of claim 1 in which said one-piece vane segment includes a central hub extending longitudinally along a central of the vane segment, and said vane elements of upstream and downstream vane sections each extend radially outwardly of said central hub.

3. The spray nozzle assembly of claim 2 in which said one-piece vane segment includes an integrally formed outer cylindrical collar disposed in surrounding relation to the vane elements of both said upstream and downstream vane sections such that the central hub, vane elements, and outer cylindrical collar circumferentially enclose said plurality of laminar flow passageways that extend axially through the vane sections.

4. A spray nozzle assembly of claim 2 in which said central hub of said one-piece vane segment has an upstream protrusion extending upstream of said upstream vane section, said upstream protrusion having a frustoconical outer guide surface tapered outwardly in a downstream direction for guiding liquid into said circumferential spaced laminar flow passageways of said upstream vane section.

5. A spray nozzle assembly of claim 4 in which said central hub has an axial passage extending through the hub for defining a further laminar flow passageway, and said frustoconical guide surface of said upstream hub protrusion intersects the axial passage of said hub to form a pointed annular upstream end of the upstream protrusion for dividing liquid flow for direction through said central hub laminar passageway and onto said frustoconical guide surface of said upstream protrusion.

6. A spray nozzle assembly of claim 4 in which said vane elements of the upstream and downstream vane sections have upstream pointed ends for dividing liquid flow into respective circumferential laminar flow passageways of the respective vane section.

7. A spray nozzle assembly of claim 4 in which said central hub has a downstream frustoconical protrusion tapered inwardly in downstream direction for guiding liquid from said circumferentially spaced laminar flow passages of said downstream vane section.

8. The spray nozzle assembly of claim 2 in which said vane sections each have a similar number of vane elements.

9. The spray nozzle assembly of claim 2 in which the vane elements of said upstream and downstream vane sections are in circumferentially offset relation to each other such that the radial vane elements of said downstream vane section are oriented in substantially centered relation to pairs of radial vane elements of the upstream vane section when viewed in an axial direction thereof

10. The spray nozzle assembly of claim 2 in which said vane sections are disposed in axially spaced relation to each other so as to define a transition passageway between said vane sections.

11. The spray nozzle assembly of claim 1 in which said liquid inlet is defined by a strainer formed with a plurality of longitudinal openings disposed circumferentially about the strainer in parallel relation to a longitudinal axis of said elongated nozzle body.

12. A high impact liquid spray nozzle assembly comprising an elongated nozzle body having a liquid flow passageway, said elongated nozzle body including an upstream body section having a liquid inlet and a downstream body section including a high impact attachment tube having a liquid passageway that extends with an inwardly tapered diameter in a downstream direction along a longitudinal axis of the liquid passage, a spray tip at a downstream end of said nozzle body having an elongated discharge orifice oriented transverse to the longitudinal axis of the liquid passageway for emitting and directing a flat liquid spray pattern, a liquid inlet communicating with an upstream end of said nozzle body liquid passageway, a one-piece vane segment interposed between said upstream and downstream nozzle body sections through which liquid directed through said liquid flow passageway passes, said one-piece vane segment comprising an upstream vane section and a downstream vane section downstream of said upstream vane section, said upstream and downstream vane sections each having a plurality of flat vane elements defining a plurality of longitudinally extending circumferentially spaced laminar flow passageways communicating between said liquid inlet and said spray tip for directing liquid longitudinally in a direction parallel to the longitudinal axis of the liquid passageway, and said radial vane elements of said downstream vane section being circumferentially offset to the radial vane elements of said upstream vane section.

13. A spray nozzle assembly of claim 12 in which said one-piece vane segment is connected in interposed relation between said upstream and downstream nozzle body sections.

14. A spray nozzle assembly of claim 12 in which said vane segment has a cylindrical collar integral with vane elements of said upstream and downstream vane sections, and said outer cylindrical collar has an upstream end secured to said upstream body section and a downstream end secured to said downstream nozzle body section.

15. The spray nozzle assembly of claim 12 in which said one-piece vane segment includes a central hub extending longitudinally along a central axis thereof, and said vane elements of upstream and downstream vane sections each extend radially outwardly of said central hub.

16. The spray nozzle assembly of claim 15 in which said one-piece vane segment includes an integrally formed outer cylindrical collar disposed in surrounding relation to the vane elements of both said upstream and downstream vane sections such that the central hub, vane elements, and outer cylindrical collar circumferentially enclose said plurality of laminar flow passageways that extend axially through the vane sections.

17. A spray nozzle assembly of claim 16 in which said central hub has an axial passage extending through the hub for defining a further laminar flow passageway.

18. A spray nozzle assembly of claim 16 in which said central hub of said one-piece vane segment has an upstream protrusion extending upstream of said upstream vane section, said upstream protrusion having a frustoconical outer guide surface tapered outwardly in a downstream direction for guiding liquid into said circumferential spaced laminar flow passageways of said upstream vane section.

19. A spray nozzle assembly of claim 18 in which said central hub has an axial passage extending through the hub for defining a further laminar flow passageway, and said frustoconical guide surface of said upstream hub protrusion intersects the axial passage of said hub to form a pointed annular upstream end of the upstream protrusion for dividing liquid flow for direction through said central hub laminar passageway and onto said frustoconical guide surface of said upstream protrusion.

20. A spray nozzle assembly of claim 19 in which said vane elements of the upstream and downstream vane sections have upstream pointed ends for dividing liquid flow into respective circumferential laminar flow passageways of the respective vane section.
